(19) United States
(12) Patent Application Publication
(10) Pub. No.: US 2004/0136699 A1
(43) Pub. Date: Jul. 15, 2004

(54) Digital prismatic disc format

(76) Inventors: Demetrius Ramone Ross, Denver, CO (US); Christine Diane Lobato-Ross, Denver, CO (US); Lewis Rufus Dodds, Aurora, CO (US)

Correspondence Address: DEMETRIUS R. ROSS, 4720 BLACKHAWK WAY, DENVER, CO, 80239-4968, US

(21) Appl. No.: 10/341,152

(22) Filed: Jan. 13, 2003

(51) Int. Cl. H04N 5/781

(52) U.S. Cl. 386/125; 386/126

(57) ABSTRACT

Digital Prismtic Disc Format (DPD) is a new optical media and format that uses technology based upon Dense Wavelength Division Multiplexing (DWDM) principles, a process that splits normal, white fiber-optic light into a prismatic spectrum of light used specifically to encode, decode and transport data. DPD is a new interactive system and process that transports audio, video and control signals from origination point to destination point requiring the use of special hardware and software that can translate the optical coding scheme. Included in the embodiment of the DPD system are the necessary DPD-ready components such as encoders, decoders, players, recorders, amplifiers, receivers, repeaters, interactive speakers and stands, 3D lighting, discography media and software. DPD delivers a more realistic solution for the recording and playback of sound and picture. DPD is the catalyst for enhanced hologram technology.

### CROSS-REFERENCE TO RELATED APPLICATIONS

References Cited [Referenced By] U.S. Patent Documents 20020173888 November, 2002 Aircraft Location and Tracking System Appl. No. 10/037,880.

### Other References

“International Engineering Consortium”., www.iec.org., Dense Wavelength Division Multiplexing.

“Digital Audio Industrial Supply”., www.daisy-laser.com/val1250.htm, VAL 1250/01, CD Loader for professional Audio/Video applications. Phillips Optical Storage Commercial Product Specification. December 1998.

### BACKGROUND OF THE INVENTION

This invention relates generally to a new format of transmitting, receiving, encoding and decoding audio and video data called DPD. This is a process that is totally new to audio and video end devices for industry consumers, but not a new concept in the Information Technology world. Dense Wavelength Division Multiplexing or DWDM is an optical process that allows more data bandwidth to be attained using another technical data time-sharing synchronization process called, TDM (Time Division Multiplexing).

Digital Prismatic Disc is a new proposed optical format and spectral transmission design developed to deliver the most realistic duplication of audio and video to date.

For example, this is a new format making it possible to produce a movie filmed with over 20 cameras that provide the most intriguing angles ever and a sound system of over 20 speakers delivering strategically-placed cinematic surround sound and this is only a small fraction DPD's potential. Not only will it sound better but also it will have a similar sonic impact as comparing a standard CD and a vinyl record, because the sampling frequency could more than be doubled to 96K (Kilohertz). DPD Codes (Coding/Decoding) will be unique in function to this particular system. DPD format will be encoded in the recording stage and decoded at the listening stage, usually at the amplifier / receiver, providing a high-end digital solution.

In the high-end networking industry there is a process called Dense Wavelength Division Multiplexing (DWDM) that allows more channels or frequencies over fiber-optic networks. DWDM takes a normal white optical light and splits into multiple colors by using a prism. The light is then intensified to accommodate density, like a concentrated rainbow with approximately 64 different color variations. The light is encoded at the transmitter or sender side and decoded on the receiver side. With 64 colors or coding variations, each color of light has a unique function that it may perform. Literally, approximately 64 functions or processes can be delivered simultaneously, cleaner and clearer than ever before. In the data world high-end telephone company equipment and cable company equipment often distribute data in its primary network infrastructure, often referred to as, “The Backbone”, in this fashion.

Now, with this new light coding system, it is possible to inject aspects of this existing DWDM technology and apply it in the recording industry for both audio and visual-based applications. The more we can separate and isolate audio and video signals from beginning stage to end stage, the more realistic and sonically viable that signal will be. This audio scenario is given to help further explain the many functional capabilities and technical possibilities of DPD and to give greater insight into the format. For example, color-coded separation of rays, by using this format, is how DPD may encode 20 speakers to play different pieces of the sound puzzle simultaneously. Time and protocol synchronization of these individual features working in harmony embodies the system.

In the same manner, that is why a 4-track recording typically sounds better than a 2-track recording and a 24-track recording typically sounds better than a 16-track recording. Individual sounds are isolated and enhanced to achieve maximum fidelity. Here is an example of recording an orchestra from an audio engineer's perspective. First, microphones are strategically placed to capture the acoustics and sonic resonance of the room. Sounds are isolated on tracks and grouped together in the end instead of meshing the sounds together initially. This is done so that each isolated sound can be equalized (EQ'd), a process that manipulates natural sound. Effects may be added, such as placing the violins in a large hall and the flutes in a small room. The violins may also be gated, a process that filters out background noise when there is a slight pause in the sound. Slight echo may also be inserted in a certain section of the flute section's ensemble. Then, in the end each sounds volume may be adjusted or mixed to produce the desired decibel level. The finished piece may also be EQ'd as a group, edited to fit a time format and compressed to keep the volume level boosted within a certain desired range. This is an example of a professional audio recording process.

DPD will read a very broad spectrum of colors and will even be able to recognize certain types of light that the human eye cannot see, such as ultra-violet light. The DPD player will have a more accurate laser lens that reads the disc in this multi-prismatic format. The light signals are then preferably sent to a high definition television monitor or a DPD-ready digital speaker system. Encoding devices will be developed to format the material in music and film production studios. There are many possible combinations and scenarios that can be derived from the increased bandwidth.

Another capability would be using the same existing CD (Compact Disc), DVD (Digital Versatile Disc or Digital Video Disc) and MP3 (Music Protocol 3) formats, but be able to fit more songs and movies on one disc. The dense wavelength format will compact the data allowing for more space on the media. On the average, most CDs hold a storage capacity limit of approximately 80 minutes when recording an uncompressed audio wave file. This format has the capability of storing hours of songs. Increased fidelity could also be attained if there were only 80 minutes of songs on the disc by increasing the sample clock rate. Or even more spectacular, we could program cellos to play out of speakers 1 and 2, violins out of 3 and 4, flutes out of 5 and 6, etc. These are examples of DPD's versatility and unique operational capabilities.

Within the coding of the software, the control data is greatly enhanced due to the increased storage capacity on the disc itself. Monitoring, encoding, setting and controlling the various parameters may be applied here. Also, external system and environmental controls that actually have nothing to do with the audio and video tracks being played can be found here. System and environmental controls may be user interactive and easily interfaceable based upon the end user's system configuration. For example, it is possible to control the motion of the speakers with specially designed robotic DPD interactive speaker stands that rotate to various preset degrees to give an acoustically controlled effect of moving sound. Instead of fixed speakers panning from one speaker to the next, the sound waves would move, like a moving object such as a car would drive past the listener delivering a distinct, more realistic sound. This motion and sound mixture is a distinct characteristic of DPD and DPD environmental data. Other environmental and system controls include vibration and motion devices attached to chairs and selected pieces of furniture that gives the end user a sense of being a part of the scene, instead of a spectator. Supplemental digital prismatic 3D (Dimensional) lighting devices psychologically give the motion picture a more realistic presence. All information may be recorded on the disc to engage and control active system components. New potential environmental DPD devices and known DPD interactive system devices such as those described above may participate in the DPD interactive entertainment system.

DPD represents the natural progressive evolution of audio/visual performance. Similar technology and infrastructure already exists on the high-end side of the data world. The goal of this format is to harness similar aspects of DWDM technology for the recording industry and make it an alternative and affordable system to consumers. Now, that many consumer digital electronics are more affordable and widespread, DPD technology can soon be made readily available and accessible to the general public.

CDs, DVDs, and MP3s and their perspective hardware counterparts provide entertainment to millions of people in a multi-billion dollar industry. DPDs provide improved sonic quality and enhanced video clarity because a higher sampling frequency may be used and the signals are generally given a greater bandwidth from origination to destination, thereby enhancing the AV (Audio/Visual) experience.

### BRIEF SUMMARY OF THE INVENTION

An optical format that applies the similar principals of DWDM that have been formulated to transmit and receive digitally enhanced audio and video signals, respectively named DPD. The prismatic spectrum of light allows for increased bandwidth and increased sample frequency rates well beyond 192K. The result is a more realistic reproduction of sound and picture.

In accordance with the present invention, the DPD format not only relates to the embodiment and technical process, but also to the equipment necessary to provide this end-to-end solution. Hardware and software collaboration is necessary to form the DPD system. DPD enabled equipment include encoders, decoders, amplifiers, repeaters, receivers, players, recorders and full feature software applications. The digital prismatic disc itself is also a complete new media design type, similar to a CD and more particularly similar to a DVD, but is read with a spectrum laser lens instead.

In accordance with the present invention, DPD format allows for more recording space on the disc media itself when compared to a DVD. However, in some instances, lower frequency sample rates and software compression schemes may be utilized. Also, DPD format allows for more devices to actively participate in the coding and decoding process. For example, more cameras and more speakers can contribute in the final presentation of the overall finished product. A surround sound system that is designed to accommodate eight audio speakers *(7.1) can now be designed to accommodate sixteen audio speakers *(14.2).

DPD will effectively be the catalyst for improved hologram video displays and hologram pinpoint sound origination and placement. This is due to its overall increased capacity and bandwidth. As will be discussed in greater detail, the present invention, its format and corresponding devices have an advantage over known DVD format and corresponding devices and numerous other features that make this format unique.

*7.1 is an audio speaker configuration that accommodates 7 wide range speakers and 1 sub-woofer (Bass) speaker. 14.2 thereby doubles the previous configuration activating a combination of 14 wide range speakers and 2 sub-woofers.

### BRIEF DESCRIPTION OF THE SEVERAL VIEWS OF THE DRAWING

These drawings help to visually display the embodiment of the invention, showing multiple views, aspects, components and features accompanied by a brief itemized description.

FIG. 1 is a pictorial view and conceptual flowchart of the DPD format signaling process that comprises the invention as it pertains to a DPD Amplifier/Receiver.

FIG. 2 is a perspective view and conceptual embodiment of a DPD Format device component, more specifically a DPD player/recorder. Drawing specifications were selected for this particular device because most of the DPD features that participate in the DPD format are incorporated in this particular piece of equipment. The features of this device include a DPD encoder, decoder, spectrum laser head, software and other specialized sub-components that make up the system.

### DETAILED DESCRIPTION OF THE INVENTION

As previously mentioned, many consumers have CD, DVD and MP3 players that they use for entertainment purposes. They may even own one device that can play all three formats. The DPD format software and system proposed by this invention use a special spectral laser lens to optically read and capture prismatic-coded information. DPD is an optical format that is closely related to DWDM.

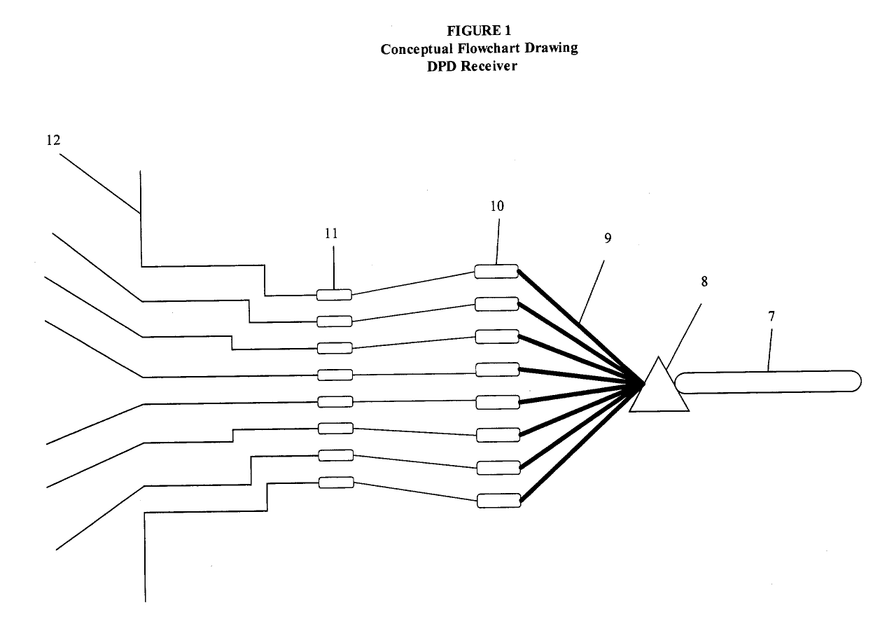

FIG. 1

In the flowchart described below, there are various audio and video signals that are being read from the DPD optical disc and then compiled into one data stream. This is called multiplexing or grouping together in one concentrated data stream for speed and efficiency. It is also referred to as a Mux (Multiplexer). The data is then isolated into multiple colors and then travels to its distinct color-coded destination. During this process of separation, Demuxing, (Demultiplexing) it is possible that each color stream of information can travel at a different speed and be relevant to a different function. In this process, the bit rate per second may vary by color. Under the majority of calculated circumstances, the overall throughput is enhanced providing greater bandwidth management. Pertaining to this system, bandwidth is defined as the amount of data that can flow through the size of the medium or connection, often referred to as, “The Pipe”.

The numbers below in parenthesis correspond with the numbers depicted in the drawings and refer to the following:

1. Ouput Signalfrom the Digital Prismatic Disc (DPD) Player/Recorder (7).

2. Optical Prism (8).

3. Color-Coded Fiber Signals (9).

4. Prismatic Optical Demultiplexers (Demux) (10).

5. DPD Decoder Component Microchips (11).

6. Individual Signals to Receiver Component Circuitry (12).

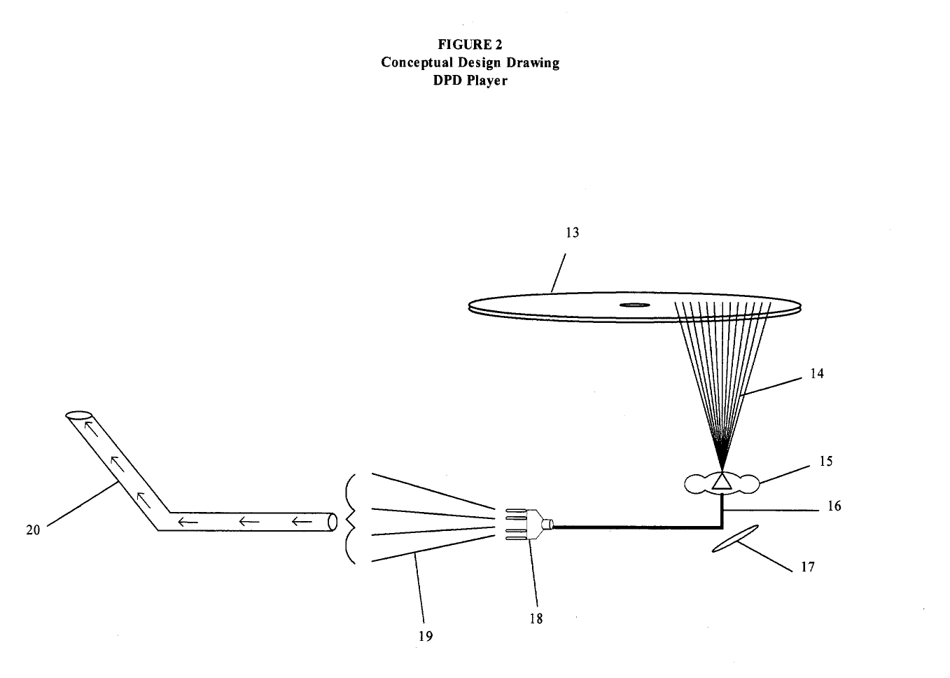

The Output Signal from the Digital Prismatic Disc (DPD) Player/Recorder 7, which is defined as the optical audio, video and control data, flows into the input of the DPD Amplifier/Receiver and enters the Optical Prism 8. The Optical Prism 8 separates the data by speed of transmission, type and protocol into distinct Color-Coded Fiber Signals 9. The spectral-enhanced Color-Coded Fiber Signals 9 are then decoded and demultiplexed by the Prismatic Optical Demultiplexers (Demux) 10. The DPD Decoder Component Microchips 11 then assigns the demuxed-digitized signals to a specific function. The distinct Individual Signals to Receiver Component Circuitry 12 is then further processed and later terminated at its specifically designed destination. FIG. 2

This illustration is a conceptual drawing of the laser transport assembly. Depicted in the drawing is the prismatic laser lens, the DPD disc, the mirror, the prism, the laser generating components such as the photo diodes, etc. Also, shown is the path of the data stream and how it can disseminate data to separate distinct destinations to perform its specific function.

The numbers below in parenthesis correspond with the numbers depicted in the drawings and refer to the following:

1. DPD Optical Media (13).

2. Spectral Lasers (14).

3. Prismatic Laser Lens (15).

4. Laser Beam (16).

5. Mirror (17).

6. Photo Diode (18).

7. Concentrated Signals (19)

(To DPD Player/Recorder Encoding, Processing, System and Other Various Sub-components).

8. DPD Optical Input Signal to DPD Amplifer/Receiver (20).

The DPD Optical Media 13 is placed into the tray of the loading mechanism of the DPD Player/Recorder, when the play function is engaged and scanned by the Prismatic Laser Lens 15. The Prismatic Laser Lens 15 scans and reads the encoded information by utilizing a wide array of Spectral Lasers 14. The data is then multiplexed into a collective concentrated Laser Beam 16 and precisely reflected by the Mirror 17 and angled to be processed and read through the Photo Diode 18. The Photo Diode 18 then disseminates the Concentrated Signals 19 to the appropriate processors, circuits and microchips. The final Concentrated Signal 19 is then sent through the output of the DPD Player/Recorder to be directly connected to the input of the DPD Amplifier/Receiver for further processing and decoding.

We hereby claim that:

1. DPD (Digital Prismatic Disc Format) uses similar aspects of Dense Wavelength Division Multiplexing (DWDM) technology to encode and decode audio and video signals comprising:
DPD software, programs that are technically engineered to execute the process to encode and decode digital optical prismatic disc formats for audio and video signals;
A hardware component DPD encoding device is technically engineered to encode digital optical prismatic disc formats for audio and video signals;
A hardware component DPD decoding and receiving device is technically engineered to decode digital optical prismatic disc formats for audio and video signals and disseminate the data appropriately according to program code;
A hardware component DPD decoding and player device is technically engineered to decode digital optical prismatic disc formats for audio and video signals and disseminate the information appropriately according to program code. This player device would reproduce and play the audio with the direct aid of audio headphones and/or audio speakers by means of an amplifier/receiver device and would also reproduce and play video with the direct aid of a monitoring device, such as an HDTV (High Definition Television) monitor or screen;
A hardware component DPD combination encoding and decoding player and recording device that is technically engineered to play and record digital optical prismatic disc formats for audio and video signals. This player and recorder device physically burns (records) and masters the audio and video signals into the disc by a function called, finalizing. After the finalization process is successfully completed, the disc is able to play back the reproduced audio and video signals in the DPD format on any standard DPD player;
A DPD (disc), that is the actual discography media that is viably and technically engineered to play back digital optical prismatic disc formats for audio and video data. Also, pertaining to the recording function, DPD's that are viably and technically engineered to record DPD audio, video, control and system data.

2. The DPD audio/visual format of claim 1, comprising a color-coded process of transmitting and receiving audio and video data.

3. The DPD audio/visual format of claim 2, incorporating the aspects of DWDM technology specifically applied to audio and videodiscs and their respective hardware components.

4. The DPD audio/visual format of claim 1, comprising a unique, technically engineered prismatic optical laser lens and transport mechanism for reading spectral audio and video data in the Digital Prismatic Disc Format.

5. The DPD audio/visual format of claim 4, comprising multiple standard hardware input and output (I/O) connection types that include S-Video (Synchronous Video) and optical specifications that may include: DSA, SPDIF, TDIF, 12S, SCSI, Digital Light Pipe, Fire wire and digital wireless technologies.

6. The DPD audio/visual format of claim 1, incorporating into its design a power supply with an AC/DC (Alternating Current/Direct Current) converter directly connected to all participating micro-component circuits.

7. The DPD audio/visual format of claim 6, comprising a Class A laser device as defined by FCC (Federal Communications Commission) standards for all hardware players and recorders, and additionally, in compliance with FCC housing specifications for Class A laser devices.

8. The DPD audio/visual format of claim 1, incorporating a laser transport device that can read multiple other formats including: CD-DA, CD-ROM, CD-ROM XA, SVCD, HDCD, Video-CD, Photo-CD, CD-R, CD-RW, DVD and DVD-A. Additionally, this device may be upgraded with software and hardware to read future formats.

9. The DPD audio/visual format of claim 1, incorporating the similar technology of DWDM, can transmit and receive different digital protocols and speeds simultaneously on various color-coded spectrums of light.

10. The DPD audio/visual format of claim 4, embodying an array of laser photo diodes, mirrors and circuits.

11. The DPD audio/visual format of claim 2, embodying distinct color-coded paths that can be utilized to control distinct and separate functions.

12. The DPD audio/visual format of claim 11, allows for a higher bit rate than CD or DVD, which translates to a higher audio/visual fidelity.

13. The DPD audio/visual format of claim 2, is a totally new and unique process when applied to media and audio/visual end devices that are equipped to encode and decode this prismatic optical format. Specific devices include but are not limited to: Cameras, microphones, audio/video cables, mixing boards and consoles, digital audio tape players/recorders, video tape players/recorders, CD players/recorders, DVD players/recorders, amplifiers, audio/video receivers, equalizers, televisions, high-definition televisions, monitors, computer network cards, telephone lines, coaxial cable, cable receivers, satellite receivers, satellite transmission devices, digital radio frequencies, satellite frequencies, software applications, etc.
